(19) United States
(12) Patent Application Publication
(10) Pub. No.: US 2008/0216461 A1
(43) Pub. Date: Sep. 11, 2008

(54) Micro Gas Turbine System

(76) Inventors: Susumu Nakano, Hitachi (JP); Satoshi Dodo, Kasama (JP); Hisamichi Inoue, Takahagi (JP); Hiroyuki Shiraiwa, Hitachi (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/995,967

(22) PCT Filed: Dec. 14, 2005
(86) PCT No.: PCT/JP2005/022939

§ 371 Date: Jan. 17, 2008

(51) Int. Cl. F02C 3/30; F02C 6/00

(52) U.S. Cl. 60/39.53; 60/39.5

(57) ABSTRACT

A micro gas turbine system is provided which increases power generation efficiency and output of power generation by means of water spray and which can exercise effective water spray control with simple control. The micro gas turbine system, according to the present invention, including a compressor, a combustor, a regenerative heat exchanger, a generator and a power transducer is provided with a plurality of spray water supply lines which include spray water nozzles and shutoff valves and which supply a prescribed amount of spray water by opening and closing the shutoff valves.

### TECHNICAL FIELD

The present invention relates generally to micro gas turbine systems applied to privately-owned power generation equipment, and in particular to a micro turbine system provided with an installation that increases output of power generation by means of water spray.

### BACKGROUND ART

A micro gas turbine system of a type that increases output of power generation by means of water spray is known from one described in e.g. JP-A-2005-140023. A regeneration cycle gas turbine system improves cycle efficiency and increases output of power generation depending on how much a regenerative heat exchanger can recover heat energy from exhaust. In order to increase the amount of heat exchange in the regenerative heat exchanger, there is a known system that performs water-spray on a compressor discharge pipe through a conducting water pipe, a flow regulation valve and a water spray nozzle. Humidification by water spray lowers the inlet temperature of low-temperature-side air of the regenerative heat exchanger to increase the amount of heat exchange in the regenerative heat exchanger, thereby increasing the amount of exhaust heat to be recovered, and to increase an air flow rate itself to a combustor.

### Patent Document 1: JP-A-2005-140023

### DISCLOSURE OF INVENTION

### Problem to be Solved by the Invention

Now, the volume of spray water is a volume required to lower, to a saturation temperature of water vapor, the temperature of air in a low-temperature-air-side (compressor discharge air) inlet state of a regenerative heat exchanger. The discharge air temperature of the compressor changes depending on the air-intake-side temperature condition, i.e. on the ambient temperature condition. Therefore, the volume of water supplied from a spray water nozzle changes depending on the ambient temperature. For example, if the volume of air needed to generate rated output at a turbine design point (ISO conditions, 15° C., 101.3 KPa, 30% relative humidity) is insufficient because of a rising ambient temperature, an flow rate increasing effect resulting from water spray can make good the shortage of air volume.

As described above, the spray water requires a wide range of flow rates depending on outside air temperatures and on desired loads. Further, since sprayed water flows into the regenerative heat exchanger, it is desirable that water drops be fully evaporated in a distance before the water drops reaching the inlet of the regenerative heat exchanger in order to avoid damage due to thermal shocks caused by adhesion of the water drops to a high-temperature wall of the regenerative heat exchanger.

If compressor discharge air is humidified by water spray, the implementation of flow control matched to the saturation temperature of water and to load demands necessitates a wide range of flow control. In order to fully evaporate spray water before it enters the regenerative heat exchanger, it is necessary to make the diameter of a water drop minute and to ensure a sufficient amount of time for the evaporation, that is, a space adapted to evaporate water drops. One advantage of the micro gas turbine is a simple structure and a small number of component parts. Another advantage is that operation control involves only control of the rotation speed and fuel flow, that is, complicate control is not involved. If water spray is involved, the control of water spray is added. In addition, if such control is intended to execute water spray control according to the saturation temperature of water, there arises a problem with complicated control of auxiliaries. Control is needed also to monitor water supplied into the system when water spray is employed, which complicates the system.

It is an object of the present invention to provide a micro gas turbine system that increases power generation efficiency and output of power generation by means of water spray and that can exercise effective water spray control with simplified control.

It is another object of the present invention to provide a micro gas turbine system that includes a water sprayer that can effectively evaporate spray water in a limited space.

### Means for Solving the Problem

(1) To achieve the objects described above, a micro turbine system according to the present invention includes: a compressor for compressing air; a combustor for burning the compressed air and fuel; a turbine driven by combustion gas generated by the combustor; a regenerative heat exchanger for performing heat exchange between the exhaust gas of the turbine and the compressed air led to the combustor; a generator for converting expansion work of the turbine into electric power; a power transducer for temporarily converting the electric power from the generator into direct current and then converting the direct current into alternating current power with a commercial frequency; and a plurality of spray water supply lines including spray water nozzles and shutoff valves and supplying a prescribed amount of spray water by opening and closing the shutoff valves.

With such a configuration, effective water spray control can be exercised with simple control.

(2) In item (1) mentioned above, preferably, the micro turbine system further includes air pipes disposed downstream of the compressor and adapted to swirl air to be discharged from the compressor on the upstream side of the direction in which the air flows into the regenerative heat exchanger, and water drops sprayed from the spray water nozzles are sprayed in the swirl formed by the air pipes.

(3) In item (1) mentioned above, preferably, the micro turbine system further includes: a circulating water pump for supplying cooling water cooling the generator and the power transducer; a circulating water tank adapted to store therein cooling water circulated by the circulating water pump; a radiator for causing the circulating water to radiate its heat energy; a water purifying apparatus for purifying water led from the outside of the system, into purified water; a spray water tank adapted to store therein water from the water purifying apparatus; a spray water pump for supplying the water stored in the spray water tank; a connection pipe for connecting the spray water tank with the circulating water tank; and a shutoff valve provided in the connection pipe.

(4) In item (3), preferably, the micro turbine system further includes: level gauges provided in the spray water tank and the circulating water tank, respectively, to measure respective water levels thereof; and water control means for operating the water purifying apparatus when the level gauge of the spray water tank is below a prescribed height; for stopping the water purifying apparatus when the level gauge of the spray water tank reaches the prescribed height; for opening the shutoff valve provided in the connection pipe connecting the circulating water tank and the spray water tank when the level gauge of the circulating water tank is below a prescribed height; and for closing the shutoff valve when the level gauge of the circulating water tank returns to the prescribed height.

(5) In item (1), preferably, the micro turbine system further includes: a circulating water pump for supplying cooling water cooling the generator and the power transducer; a circulating water tank adapted to store cooling water circulated by the circulating water pump; a radiator causing circulating water to radiate its heat energy; a water purifying apparatus for purifying water led thereto from the outside of the system, into purified water; a spray water tank adapted to store therein water from the water purifying apparatus; a spray water pump for supplying the water stored in the spray water tank; and a connection pipe for connecting an overflow pipe of the spray water tank with the circulating water tank.

(6) In item (5) mentioned above, the micro turbine system further includes: level gauges provided in the spray water tank and the circulating water tank, respectively, to measure respective water levels thereof; and water control means for operating the water purifying apparatus when any one of the level gauge of the spray water tank and the level gauge of the circulating water tank is below a prescribed height for each; and for stopping the water purifying apparatus when both the level gauges reach the prescribed heights.

(7) In item (3) or (5), preferably, the micro gas turbine system further includes a heater disposed in the circulating water tank, and when the turbine is stopped, the heater is turned on.

(8) To achieve another object, a micro gas turbine system according to the present invention includes: a compressor for compressing air; a combustor for burning the compressed air and fuel; a turbine driven by combustion gas generated by the combustor; a regenerative heat exchanger for performing heat exchange between exhaust gas of the turbine and the compressed air led to the combustor; a generator for converting expansion work of the turbine into electric power; a power transducer for temporarily converting electric power from the generator into direct current and then converting the direct current into alternating current power with a commercial frequency; and air pipes disposed downstream of the compressor and adapted to swirl air to be discharged from the compressor on the upstream side of the direction in which the air flows into the regenerative heat exchanger; and water drops sprayed from the spray water nozzles are sprayed in the swirl formed by the air pipes.

With such a configuration, spray water can effectively be evaporated in a limited space.

### EFFECT OF THE INVENTION

According to the present invention, the micro gas turbine system that increases power generation efficiency and output of power generation by water spray can effectively perform the water spray control with simple control.

### BRIEF DESCRIPTION OF DRAWINGS

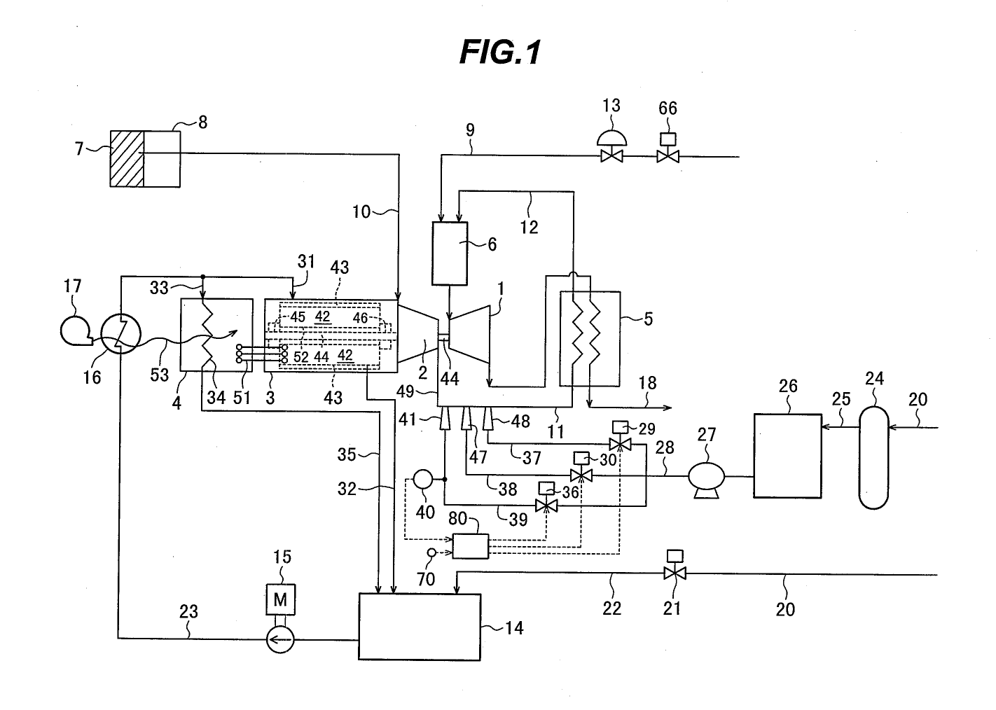

### [FIG. 1]

FIG. 1 is a system configuration diagram of a micro gas turbine system according to a first embodiment of the present invention.

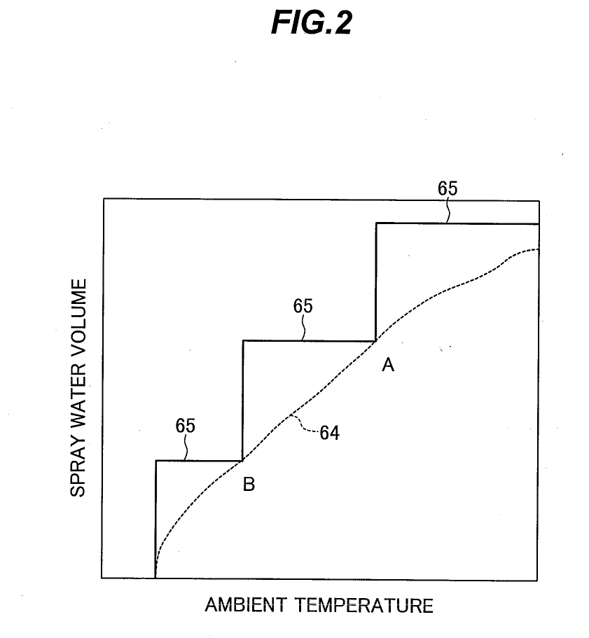

### [FIG. 2]

FIG. 2 is a diagram for assistance in explaining details of controlling spray water volume in the micro gas turbine system according to the first embodiment of the present invention.

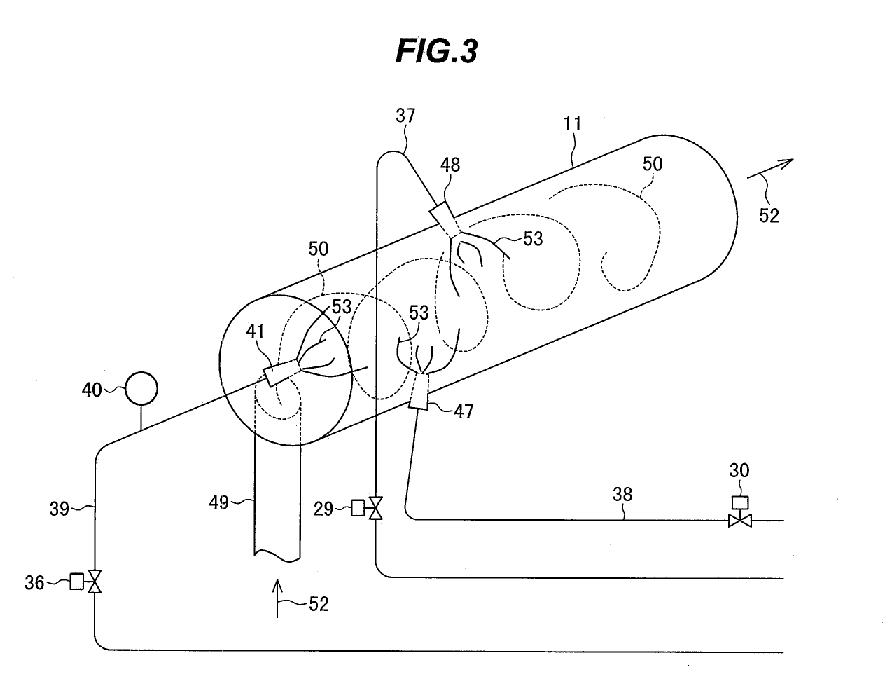

### [FIG. 3]

FIG. 3 is a perspective view illustrating the installation of a plurality of spray nozzles in the micro gas turbine system according to the first embodiment of the present invention.

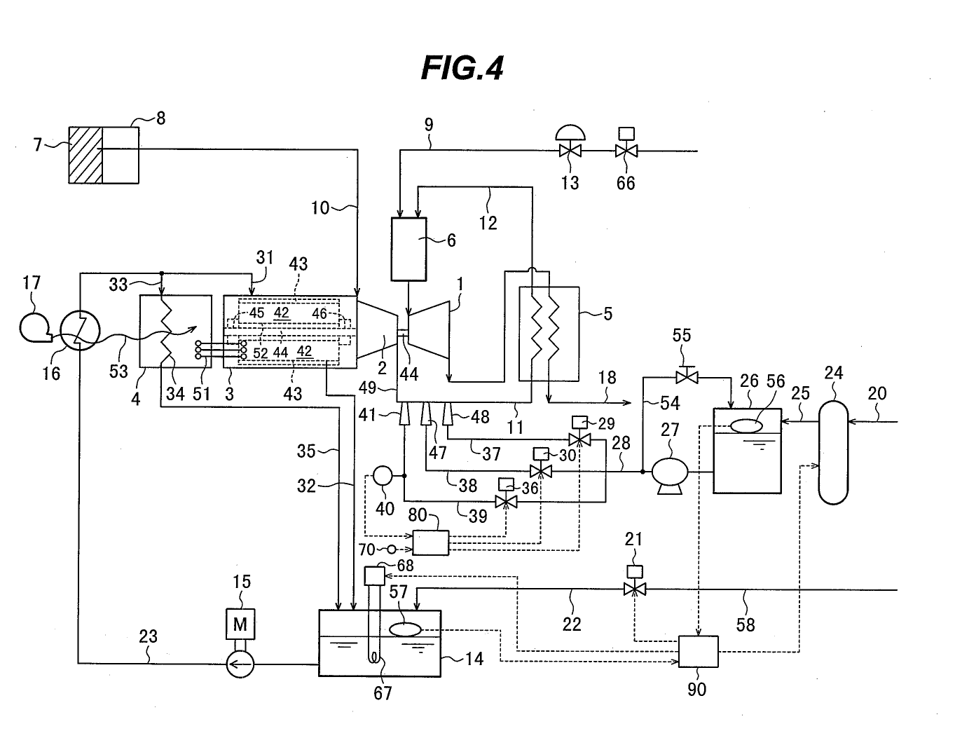

### [FIG. 4]

FIG. 4 is a system configuration diagram of a micro gas turbine system according to a second embodiment of the present invention.

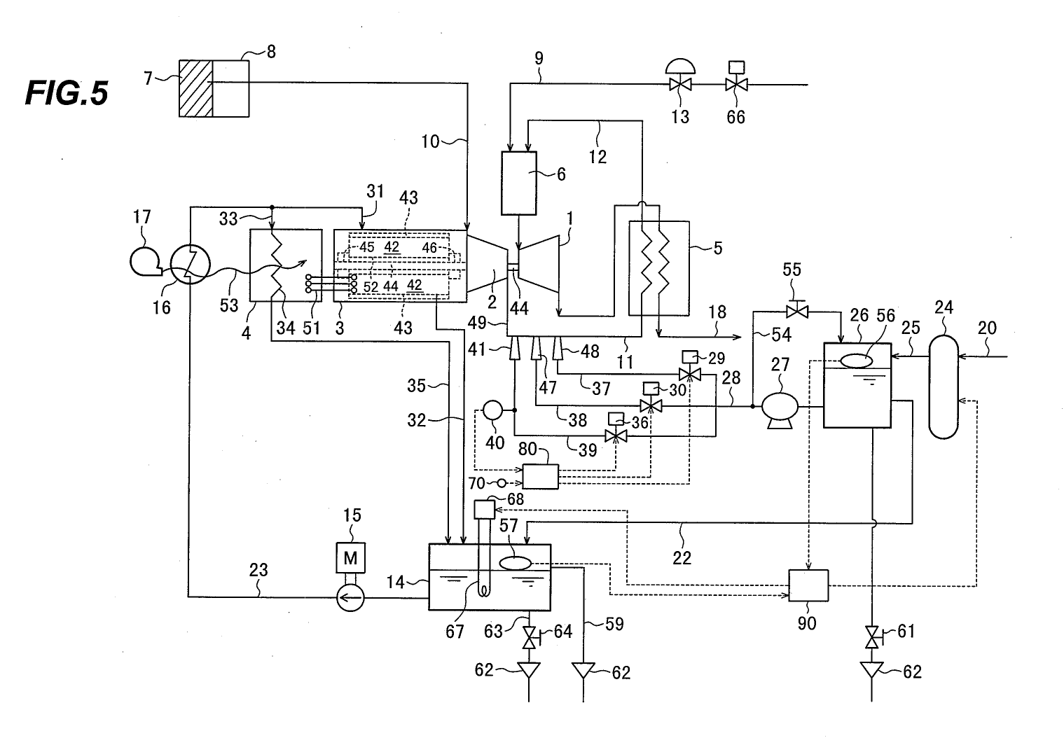

### [FIG. 5]

FIG. 5 is a system configuration diagram of a micro gas turbine system according to a third embodiment of the present invention.

### EXPLANATION OF REFERENCE NUMERALS

1 . . . Turbine
2 . . . Compressor
3 . . . Generator
4 . . . Power transducer
5 . . . Regenerative heat exchanger
6 . . . Combustor
7 . . . Air intake filter
8 . . . Air intake silencer
9 . . . Fuel pipe
10 . . . Air intake pipe
11 . . . Compressor discharge air pipe
13 . . . Fuel flow regulating valve
14 . . . Circulating water tank
15 . . . Circulating water pump
16 . . . Radiator
17 . . . Radiator fan
20 . . . Water conducting pipe
22, 23, 25, 35, 37, 38, 39 . . . Pipe
24 . . . Water purifying apparatus
26 . . . Spray water tank
27 . . . Spray water pump
29, 30, 36, 21 . . . Shutoff valve
34 . . . Power transducer's built-in cooler
40 . . . Pressure gauge
41, 47, 48 . . . Spray water nozzle
42 . . . Stator coil
43 . . . Generator cooling jacket
44 . . . Generator rotor
45 . . . Generator end bearing
46 . . . Compressor side bearing
48 . . . Air pipe
51 . . . Power line
56, 57 . . . Level gauge
67 . . . Heater
70 . . . Temperature sensor
80 . . . Spray water control means
90 . . . Water control means

### BEST MODE FOR CARRYING OUT THE INVENTION

A description will hereinafter be made of the configuration and operation of a micro gas turbine system according to a first embodiment of the present invention with reference to FIGS. 1 to 3.

The configuration of the micro gas turbine system according to the first embodiment of the present invention is first described with reference to FIG. 1.

FIG. 1 is a system configuration diagram of the micro gas turbine system according to the first embodiment of the present invention.

The micro gas turbine system illustrated in FIG. 1 is a gas turbine system composed of a regeneration cycle that includes a turbine 1, a compressor 2, a generator 3, a power transducer 4, a regenerative heat exchanger 5 and a combustor 6.

The generator 3 is a permanent magnet three-phase generator which uses a permanent magnet to generate a magnetic field, and the permanent magnet is attached to a rotor 44. A stator coil 42 is installed in such a way to surround the rotor 44. The compressor 2 and the turbine 1 are attached to the extension end of the shaft of the rotor 44. The rotor 44 is carried by a generator end side bearing 45 and by a compressor side bearing 46. The generator 3 is connected to the power transducer 4 via power lines 51. The power transducer 4 includes a converter which converts AC power into direct power and an inverter which converts the DC power into AC power matched to a commercial frequency.

When the operation of the turbine system is started, electricity is supplied from a system side not shown to the generator 3 for its operation as an electric motor. A driving shaft 44 is rotated to rotate the compressor 2 and the turbine 1. The compressor 2 sucks outside air from a pipe 10 via a filter 7 and a silencer 8, increasing the pressure of the outside air, feeding the pressurized outside air to the regenerative heat exchanger 5 via a pipe 11, and thus supplies the outside air discharged therefrom to the combustor 6 via a pipe 12. The pressure of the discharged outside air is increased with an increase in the rotation speed of the rotor 44. When the rotation speed of the rotor or the discharge pressure reaches a particular prescribed value, a shutoff valve 64 and a fuel flow regulating valve 13 installed on a fuel supply line 9 are opened to feed fuel to the combustor 6 to mix the fuel with the outside air discharged from the compressor 2 for combustion. The combustion gas performs expansion work in the turbine 1, passing through the regenerative heat exchanger 5, and is then discharged to the outside of the turbine system through an exhaust duct 18. In the regenerative heat exchanger 5, the exhaust gas from the turbine heats the air discharged from the compressor and supplied through the pipe 11. When the generator 3 starts to generate electric power by the increased expansion work of the combustion gas in the turbine 1, the power transducer 4 converts the electric power into electric power with the frequency of the system-side electric power and outputs it.

The turbine system internally uses water to cool the generator 3 and power transducer 4. The cooling water is stored in a circulating water tank 14 and supplied by a circulating water pump 15 to a radiator 16 via a pipe 23. In the radiator 16, air sent from a blower 17 draws an amount of heat from circulating water to lower the temperature of the water. The circulating water passing through the radiator 16 is dividedly led to a pipe 31 and to a pipe 33. The pipe 31 is adapted to supply the water to a cooling jacket 43 of the generator 3. The water supplied to the cooling jacket 43 is returned to the circulating water tank 14 through the pipe 32. The circulating water dividedly led to the pipe 33 is supplied to a cooling jacket 34 of the power transducer 4 and returned to the circulating water tank 14 through a pipe 35. The circulating water tank is connected to a water conducting pipe 20 via a pipe 22 and via a shutoff valve 21, and water is supplied to the circulating water tank from the outside of the turbine system.

On the other hand, provided on the side of spray water supply lines are the water conducting pipe 20, a water purifying apparatus 24 of a reverse osmosis membrane type or the like, a spray water tank 26, a pipe 25 connecting the spray water tank 26 with the water purifying apparatus 24, a spray water pump 27, three (first, second and third) spray water supply lines, and a pipe 28 connecting such lines with the spray water pump 27. The first spray water supply line includes a spray water nozzle 48, a spray water supply pipe 37 and a shutoff valve 29. The second spray water supply line includes a spray water nozzle 47, a spray water supply pipe 38 and a shutoff valve 30. The third spray water supply line includes a spray water nozzle 41, a spray water supply pipe 39 and a shutoff valve 36.

The water purifying apparatus 24 removes hard substances such as silica, potassium and the like and sodium components mixed or dissolved in water fed from the outside of the turbine system through the water conducting pipe 20 and provides spray water. The spray water stored in the spray water tank 26 is supplied to the spray water lines by the spray water pump 27. If all the shutoff valves 29, 30, and 36 of the respective spray water lines are opened, the spray water is sprayed into the compressor discharge air pipe 11 from the three spray water nozzles 41, 47, and 48. This is the case where the flow rate of spray water to be supplied becomes a maximum. In contrast, when only the shutoff valve 36 is opened and the other two shutoff valves are closed, the flow rate of spray water becomes a minimum. In other words, in the present embodiment, the flow rate of spray water can be switched to one of the three stages by the opening and closing control of the shutoff valves 29, 30, and 36. It is to be noted that a pipe 49 is provided upstream of the compressor discharge air pipe 11 such that the pipe 49 is perpendicular thereto. The pipe 49 is described later with reference to FIG. 3.

Spray water volume control means 80 controls the opening and closing of the shutoff valves 29, 30, and 36 according to ambient temperatures detected by a temperature sensor 70. In this case, the spray water volume control means 80 estimates a flow rate of spray water according to the spray supply pressure of the spray water nozzle detected by a pressure gauge 40 located on the upstream side of the spray water nozzle 41. The control operation of the spry water volume control means 80 is described later with reference to FIG. 2.

Now, a description is made of the details of controlling the spray water volume in the micro gas turbine system according to the first embodiment of the present invention with reference to FIG. 2.

FIG. 2 is a graph for assistance in explaining the details of controlling the spray water volume in the micro gas turbine system according to the first embodiment of the present invention.

The flow rate of spray water required to keep a load request constant with respect to ambient temperature is represented by a line segment 64 indicating a saturated amount of water until ambient temperature A shown in FIG. 2 is reached. If spray water volume is to be controlled according to the saturation curve, it is necessary to continuously control the flow rate of spray water according to changes in ambient temperature. However, in the present embodiment, the spray water volume control means 80 opens only the shutoff valve 36 to supply spray water only from the spray water nozzle 41 until ambient temperature B is reached. If ambient temperature B is exceeded, the spray water volume control means 80 also opens the shutoff valve 30 to supply spray water from the two nozzles, the spray water nozzles 47 and 41. Further, if ambient temperature A is exceeded, the spray water volume control means 80 opens all the shutoff valves 29, 30, and 36 to supply spray water from the three spray nozzles 41, 47, and 48.

As described above, the present embodiment controls only the opening and closing of the three shutoff valves 29, 30, and 36 to control the spray water flow rate in three levels, thereby providing simplified control.

As shown in FIG. 1, the pressure gauge 40 is installed on the upstream side of the spray water nozzle 41 in the present embodiment. It is to be noted that the pressure gauge may be installed on the upstream side of each of the nozzles 41, 47, and 48. The spray water volume can be calculated from a spray water supply pressure by preliminarily determining a characteristic curve of the spray supply pressure and flow rate of the spray water nozzle. In the example of FIG. 1, the lines on the downstream side of the pipe 28 are configured so that the pipes extending from the spray water pump 27 to each of the spray water nozzles may have the same pipe resistance. Thus, the spray water volume control means 80 in the turbine system can determine a spray water flow rate by determining a pressure of spray water supplied to the spray water nozzle 41 in the case of supplying spray water through two spray water nozzles as well as through three spray water nozzles.

Since the spray water nozzle used in the present embodiment provides a minute water droplet of about 20 μm, the spray water supply pressure is as high as 70 to 100 atm.

Incidentally, three spray water lines are installed on the discharge side of the compressor in the example of FIG. 1. However, a plurality of, e.g. four or more, nozzles may be installed to increase water spray volume.

A description is next made of the installation of the plurality of the spray nozzles in the micro gas turbine system according to the first embodiment of the present invention with reference to FIG. 3.

FIG. 3 is a perspective view illustrating the installation of the plurality of the spray nozzles in the micro gas turbine system according to the first embodiment of the present invention.

As shown in FIG. 1, the pipe 49 is connected to the discharge pipe of the compressor 2. The pipe 49 is joined to the lateral surface of the compressor discharge air pipe 11. The outlet of the compressor discharge air pipe 11 is connected to the air-side inflow portion of the regenerative heat exchanger.

The spray water nozzle 41 is installed on the upstream-side end face of the compressor discharge air pipe 11. The spray nozzle 47 is installed on the lateral surface of the compressor discharge air pipe 11 on the downstream side of the spray water nozzle 41. The spray water nozzle 48 is installed further downstream of the spray nozzle 47. The spray water nozzle 47 is connected to the pipe 39, to the spray water pump (not shown in the figure) connected to the shutoff valve 36, which is a spray water supply source, and to the spray water tank (not shown in the figure). Similarly, the spray water nozzle 47 is connected to the pipe 38 and to the shutoff valve 30, and the spray water nozzle 48 is connected to the pipe 37 and to the shutoff valve 30. Air (arrow 52) discharged from the compressor flows through the pipe 49 into the compressor discharge air pipe 11 from the lateral side thereof to form a swirling flow 50. The water 53 sprayed from the three spray water nozzles 41, 47, and 48 mixes with the swirling flow 50 to provide a uniform mixture with the air. In addition, since the water 53 flows along with the swirling flow, it flows a longer distance than the axial distance of the pipe 11. This mixture promoting effect and the increased floating distance of water drops will promote the evaporation of spray water drops.

As described above, the spray water supply control in the high-pressure state in the present embodiment does not necessitate the continuous control using a flow regulating valve. Therefore, expensive auxiliaries such as a flow regulating valve are eliminated to reduce the cost of the system. Since the spray water flow rate is operatively controlled only by opening and closing the shutoff valves, it can be controlled extremely simply. The flow rates of the spray water from the plurality of the lines can sufficiently be calculated by determining a spray water supply pressure by means of the pressure gauge installed on only one line. Thus, the number of gauges can easily be reduced, and the spray water flow rate can be determined with ease.

Since the spray water nozzles 41, 47, and 48 are installed as illustrated in FIG. 3, the evaporation of spray water can be promoted even in a compressor discharge air pipe installed in a limited space, whereby increases in output and in efficiency can surely be achieved by supplying spray water.

A description is next made of the configuration of a micro gas turbine system according to a second embodiment of the present invention with reference to FIG. 4.

FIG. 4 is a system configuration diagram of the micro gas turbine system according to the second embodiment of the present invention. It is to be noted that the same reference numerals as those in FIG. 1 denote the same portions.

The configuration of the micro gas turbine system according to the present embodiment is basically the same as that illustrated in FIG. 1; however, they differ in the following two points. Firstly, the spray water supply line is provided with a line that returns to the spray water tank 26 from downstream of the spray water pump 27 via a return pipe 54 and via a valve 55. Secondly, connection of the water supply pipe to the circulating water tank is such that the water supply pipe is connected to the feed-water pipe 22 of the circulating water tank from the spray water tank 26 via a pipe 58 and via the shutoff valve 21. Thirdly, a heater 67 and a heater power supply 68 are installed in the circulating water tank.

Level gauges 56 and 57 are installed in the spray water tank 26 and the circulating water tank 14, respectively, to measure respective water levels therein. Water that is purified by the water purifying apparatus 24 to have low electrical conductance is supplied to the circulating water tank 14 because supplied thereto via the spray water tank. If the level gauge 57 of the circulating water tank 14 does not reach a prescribed height, water control means 90 opens the shutoff valve 21 to supply water from the spray water tank 26. If the level gauge 57 reaches the prescribed height, the water control means 90 closes the shutoff valve 21. If the level gauge 56 of the spray water tank 26 is below the prescribed height, the water control means 90 actuates the water purifying apparatus 24 and supplies purified water to the spray water tank. If the level gauge 56 reaches the prescribed height, the water control means 90 stops the water purifying apparatus and also stops the supply of water.

As regards the operation of the turbine system in cold climates, if the turbine is not operated, all the water in the spray water tank is drained therefrom by opening a valve 61 in order to prevent breakage of the water pipes due to freezing. On the other hand, the water in the circulating water tank 14 is supplied to machinery such as the generator, electrical transducer, radiator, etc.; thus, it is difficult to fully remove water from the piping system. Accordingly, such machinery is managed by keeping water therein. If the turbine system is shut down, the water control means 90 turns on the heater 67 to warm the water in the circulation tank. Even while the turbine is stopped, only the circulating water pump 15 is operated to supply the warmed water to the water circulating system to prevent the pipes from freezing. A similar heater may be installed in the spray water tank. When the turbine is stopped and a dew-point temperature of the atmosphere is lower than the water temperature of the circulating water tank, the heater 67 is also operated to prevent dew condensation of the generator and power transducer.

According to the present embodiment, the spray water supply control in the high-pressure state does not necessitate the continuous control using a flow regulating valve. Therefore, expensive auxiliary machinery such as the flow regulating valve is unnecessary, which can reduce the cost of the system. Since the spray water flow rate is controlled by operating only the opening and closing of the shutoff valves, the control of the spray flow rate is extremely simplified. The flow rates of the spray water from the plurality of the lines can sufficiently be calculated by determining only a spray water supply pressure by means of the pressure gauge installed on only one line. Therefore, the number of gauges can easily be reduced and the spray water flow rate can easily be determined.

The supply of spray water and the supply of water to the circulating water tank can automatically be managed. Water supplied to the turbine system can be collected at one place on the supply side of the water purifying apparatus. Further, the supply of water needed for the system can automatically be managed. Also, water supplied to the circulating water tank is supplied from the water purifying apparatus. Therefore, even if the water is applied to the cooling of the generator 3 and power transducer 4, trouble due to electrostatic charges can be prevented because the water has extremely low electric conductance.

The installation of the heater in the circulating water tank can prevent water pipes from freezing during shutdown of the turbine and the generator and power transducer from forming condensation.

A description is next made of the configuration of a micro gas turbine system according to a third embodiment of the present invention with reference to FIG. 5.

FIG. 5 is a system configuration diagram of the micro gas turbine system according to the third embodiment of the present invention. It is to be noted that the same reference numerals as those in FIG. 1 denote the same portions.

In the present embodiment, the spray water tank is provided with an overflow pipe 22, which is connected to the circulating water tank 14. Similarly, the circulating water tank is provided with an overflow pipe 59. The spray water tank 26 and the circulating water tank 14 are each provided with a drainage line. Specifically, the spray water tank is connected to a drain port 62 via a drain pipe 60 and via a valve 61. The circulating water tank is connected to a drain port 62 via a drain pipe 63 and via a valve 64. An overflow pipe 59 of the circulating water tank is also connected to a drain port 62.

In the present embodiment, when any one of the level gauge 56 of the spray water tank and the level gauge 57 of the circulating water tank is lower than a prescribed height, the water control means 90 starts to operate the water purifying apparatus 24. When both the level gauges reach the prescribed height, the water control means 90 stops the water purifying apparatus 24. The prescribed height of the level gauge of the spry water tank is made equal to the installation height of the overflow pipe.

The water control means 90 controls the operation of the purifying apparatus and the supply of water into the turbine system performed by the operation of the purifying apparatus, on the basis of the height signals of the two level gauges.

According to the present embodiment, the spray water supply control in the high-pressure state does not necessitate the continuous control using a flow rate regulating valve. Therefore, expensive auxiliaries such as a flow regulating valve are eliminated to reduce the cost of the system. Since the spray water flow rate is operatively controlled only by opening and closing the shutoff valves, it can be controlled extremely simply. The flow rates of the spray water from the plurality of the lines can sufficiently be calculated by determining a spray water supply pressure by means of the pressure gauge installed on only one line. Thus, the number of gauges can easily be reduced, and the spray water flow rate can be determined with ease.

In addition, since it is unnecessary to provide a shutoff valve between the spray water tank and the circulating water tank, the cost of auxiliaries can be reduced, and the control of shutoff valves can be eased.

1. A micro turbine system comprising:
a compressor (2) for compressing air;
a combustor (6) for burning the compressed air and fuel;
a turbine (1) driven by combustion gas generated by the combustor;
a regenerative heat exchanger (5) for performing heat exchange between the exhaust gas of the turbine and the compressed air led to the combustor;
a generator (3) for converting expansion work of the turbine into electric power;
a power transducer (4) for temporarily converting electric power from the generator into direct current and then converting the direct current into alternating current power with a commercial frequency; and
a plurality of spray water supply lines including spray water nozzles (41, 47, and 48) and shutoff valves (41, 47, and 48) and supplying a prescribed amount of spray water by opening and closing the shutoff valves.

2. The micro turbine system according to claim 1, further comprising:
air pipes (49 and 11) disposed downstream of the compressor and adapted to swirl air to be discharged from the compressor on the upstream side of the direction in which the air flows into the regenerative heat exchanger;
wherein water drops sprayed from the spray water nozzles are sprayed in the swirl formed by the air pipes.

3. The micro turbine system according to claim 1, further comprising:
a circulating water pump (15) for supplying cooling water cooling the generator and the power transducer;
a circulating water tank (14) adapted to store therein cooling water circulated by the circulating water pump;
a radiator (16) for causing the circulating water to radiate its heat energy;
a water purifying apparatus (24) for purifying water led from the outside of the system, into purified water;
a spray water tank (26) adapted to store therein water from the water purifying apparatus;
a spray water pump (27) for supplying the water stored in the spray water tank;
a connection pipe (23) for connecting the spray water tank with the circulating water tank; and
a shutoff valve (21) provided in the connection pipe.

4. The micro turbine system according to claim 3, further comprising:
level gauges (56 and 57) provided in the spray water tank and the circulating water tank, respectively, to measure respective water levels thereof; and
water control means (90) for operating the water purifying apparatus when the level gauge of the spray water tank is below a prescribed height; for stopping the water purifying apparatus when the level gauge of the spray water tank reaches the prescribed height; for opening the shutoff valve provided in the connection pipe connecting the circulating water tank with the spray water tank when the level gauge of the circulating water tank is below a prescribed height; and for closing the shutoff valve when the level gauge of the circulating water tank returns to the prescribed height.

5. The micro turbine system according to claim 1, further comprising:
a circulating water pump (15) for supplying cooling water cooling the generator and the power transducer;
a circulating water tank (14) adapted to store cooling water circulated by the circulating water pump;
a radiator (16) for causing circulating water to radiate its heat energy;
a water purifying apparatus (24) for purifying water led thereto from the outside of the system, into purified water;
a spray water tank (26) adapted to store therein water from the water purifying apparatus;
a spray water pump (27) for supplying the water stored in the spray water tank; and
a connection pipe (58) for connecting an overflow pipe of the spray water tank with the circulating water tank.

6. The micro turbine system according to claim 5, further comprising:
level gauges (56 and 57) provided in the spray water tank and the circulating water tank, respectively, to measure respective water levels thereof; and
water control means (90) for operating the water purifying apparatus when any one of the level gauge of the spray water tank and the level gauge of the circulating water tank is below a prescribed height for each; and for stopping the water purifying apparatus when both the level gauges reach the prescribed heights.

7. The micro gas turbine system according to claim 3, further comprising:
a heater (67) disposed in the circulating water tank;
wherein when the turbine is stopped, the heater is turned on.

8. A micro gas turbine system comprising:
a compressor (2) for compressing air;
a combustor (6) for burning the compressed air and fuel;
a turbine (1) driven by combustion gas generated by the combustor;
a regenerative heat exchanger (5) for performing heat exchange between exhaust gas of the turbine and the compressed air led to the combustor;
a generator (3) for converting expansion work of the turbine into electric power;
a power transducer (4) for temporarily converting electric power from the generator into direct current and then converting the direct current into alternating current power with a commercial frequency; and
air pipes (49 and 11) disposed downstream of the compressor and adapted to swirl air to be discharged from the compressor on the upstream side of the direction in which the air flows into the regenerative heat exchanger;
wherein water drops sprayed from the spray water nozzles are sprayed in the swirl formed by the air pipes.
